(19) United States
(12) Patent Application Publication
(10) Pub. No.: US 2019/0341620 A1
(43) Pub. Date: Nov. 7, 2019

(54) REDUCING HAZARD OF LITHIUM DENDRITES IN LITHIUM CELLS

(71) Applicant: Uber Technologies, Inc., San Francisco, CA (US)

(72) Inventor: Celina J. Mikolajczak, San Carlos, CA (US)

(21) Appl. No.: 16/404,510

(22) Filed: May 6, 2019

Related U.S. Application Data
(60) Provisional application No. 62/668,146, filed on May 7, 2018.

(51) Int. Cl. H01M 4/62; H01M 2/16; H01M 10/052

(52) U.S. Cl. CPC H01M 4/628; H01M 10/052; H01M 2/1686

(57) ABSTRACT

A lithium battery cell is disclosed. The lithium battery cell includes particles such as silicon oxide (e.g., glass) that can reduce thermal runaway within the battery cell due to the presence of lithium metal dendrites within the battery cell. As lithium metal dendrites heat up due to shorting a cathode and anode in the battery cell, the particles may encapsulate the lithium metal dendrites to absorb the heat and reduce the ongoing reaction within the cell.

### CROSS-REFERENCE TO RELATED APPLICATIONS

This application claims priority to U.S. Provisional Patent Application No. 62/668,146 filed on May 7, 2018, which is incorporated by reference in its entirety.

### TECHNICAL FIELD

The embodiments disclosed herein generally relate to battery cells, and more particularly to reducing the hazard of lithium dendrites in lithium battery cells.

### BACKGROUND

Lithium batteries include a family of batteries with different chemistries. Lithium batteries store electric charges chemically such that when electrodes of the lithium batteries are connected, charges flow from the battery's cathode to its anode, thereby producing an electrical current. Lithium batteries are found in many electronic devices such as laptops, cell phones, etc.

Generally, lithium batteries are categorized as either lithium metal batteries or lithium-ion batteries. A lithium metal battery is a non-rechargeable battery that has lithium metal or lithium compounds. A lithium-ion battery in contrast is a rechargeable battery where lithium is present in an ionic form in the electrolyte of the lithium-ion battery.

Generally, a lithium battery is made of two or more cells that are electrically connected together with components that allow for use of the lithium battery, such as a case, terminals, etc. Each cell is a single encased electrochemical unit having one positive electrode and one negative electrode, with a voltage difference across the electrodes.

The cells of lithium batteries are subject to the formation of lithium metal dendrites. A lithium metal dendrite is a whisker of lithium that grows within a cell. Lithium metal dendrites typically form on the surface of the anode of a cell and can cause a short with the cathode of the cell if the dendrites penetrate a separator within the cell. The short can cause heating of lithium metal within the cell which can lead to the lithium metal melting. The melted lithium metal may further react with the surrounding electrolyte and release additional heat. If the lithium metal dendrites are concentrated in mass, the heating resulting from the melted lithium metal may result in ignition of the concentrated mass of lithium metal dendrites which ultimately results in thermal runaway of the entire cell.

### SUMMARY

A lithium battery cell is disclosed. The lithium battery cell includes particles such as silicon oxide (e.g., glass) that can reduce thermal runaway within the battery cell due to the presence of lithium metal dendrites within the battery cell. As lithium metal dendrites heat up due to shorting a cathode and anode in the battery cell, the particles may encapsulate the lithium metal dendrites to absorb the heat and reduce the ongoing reaction within the cell.

In one embodiment, the particles may be disposed within a separator that is directly in contact with the anode of the battery cell. In another embodiment, the particles may be disposed within the anode and surrounded by lithium metal included in the anode.

The features and advantages described in this summary and the following detailed description are not all inclusive. Many additional features and advantages will be apparent to one of ordinary skill in the art in view of the drawings, specification and claims.

### BRIEF DESCRIPTION OF THE DRAWINGS

FIGS. 1A-1D illustrate a first embodiment of a cell using particles to reduce the risk of a dendritic short circuit of a lithium battery cell.

FIGS. 2A-2D illustrate a second embodiment of a cell using particles to reduce the risk of a dendritic short circuit of a lithium battery cell.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The embodiments herein describe structures of a cell(s) of a lithium battery that reduces the risk of a dendritic short circuit that results in cell thermal runaway reactions in the cell. The structure uses particles (e.g., glass) to slow or stop the thermal runaway reactions within the cell.

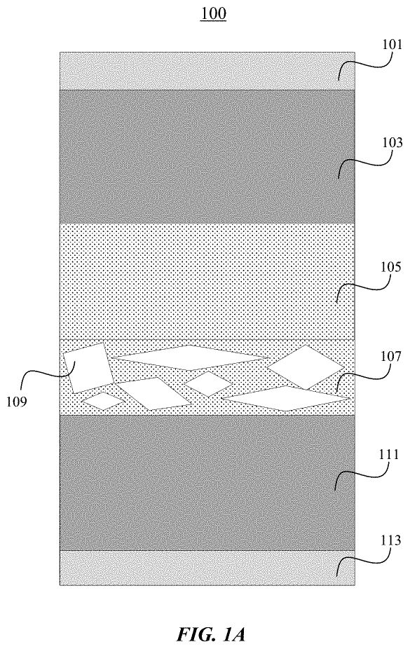

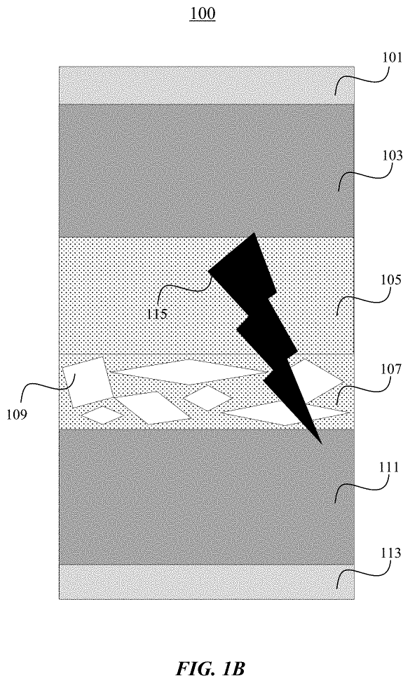

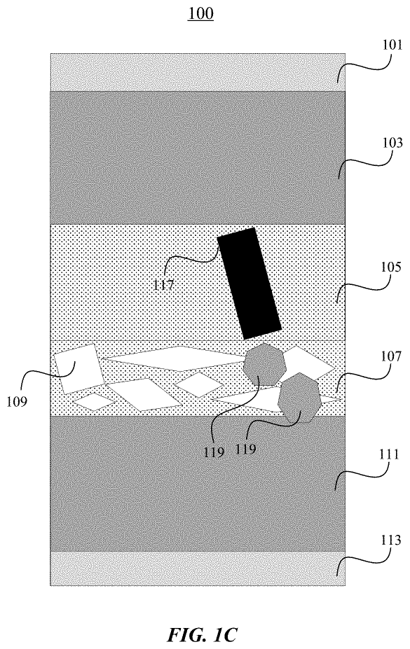

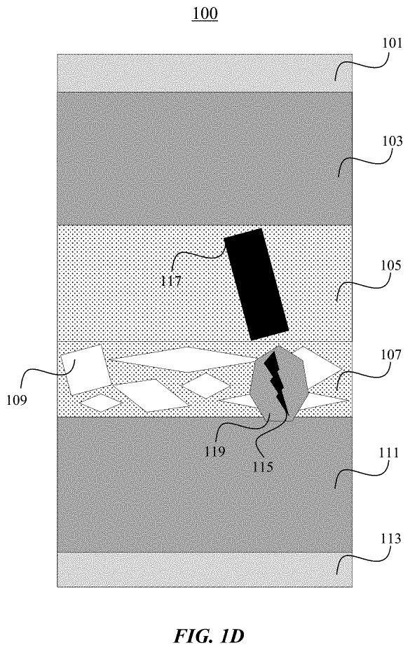

FIG. 1A illustrates a cross-section of a battery cell 100 of a lithium battery in accordance with one embodiment. The battery cell 100 includes a cathode current collector 101, a cathode 103, a separator 105, a separator 107 including particles 109, an anode 111, and an anode current collector 113 in one embodiment. Other embodiments may include further elements than those shown in FIG. 1A.

In one embodiment, the cathode current collector 101 is made of aluminum and the cathode 103 may be composed of a variety of lithiated mixed metal oxides such as cobalt oxide, nickel cobalt aluminate (NCA), nickel cobalt manganese oxide (NCM), or iron phosphate. The cell may include a lithium based liquid electrolyte or a lithium based solid electrolyte. An example of a liquid electrolyte is lithium salt in an organic solvent. An example of a solid electrolyte is lithium metal oxides. The anode currently collector 113 may be made of copper and the anode 111 may be composed of graphite, silicon oxide, carbon nano-tubes, carbon nanowires, graphene, or blends of these materials.

The separator 105 and the separator 107 are membranes, multi-layered membranes, or coated membranes placed between the cathode 303 and the anode 113. Separator 105 and separator 107 separate the cathode 303 and anode 113 from each other while still allowing the transport of ionic charge carriers that are needed during the passage of current in the cell 100. In one embodiment, the separator 105 and separator 107 may be made of a polymer film (e.g., polyethylene or polypropylene), a multi-layer polymer film, or a ceramic coated polymer film, but other substances such as non-woven fiber or ceramic materials may be used. Coatings can be applied to either side, or both sides of a separator base material.

As shown in FIG. 1A, separator layer 107 includes particles 109 whereas separator layer 105 lacks the particles 109. The particles 109 may make up 95% of the volume of the separator layer 107 in one embodiment, or they may be more sparsely dispersed in a base or binder material, or they may be mixed with particles of a variety of compositions such as aluminum oxide. Each particle 109 may have a diameter that is less than ⅓^{rd} the thickness of the separator layer 107, and less than 1 um. The particles may have a broad size and morphology distribution.

In one embodiment, the particles 109 may be made of glass (e.g., a silicon oxide material). However, the particles 109 may be made of other materials such as copper or sand. In one embodiment, the particles 109 are beads. Generally, the particles 109 have a melting point above 150 C, a glass transition temperature below 500 C, and a high enthalpy of melting such that the particles 109 can absorb heat generated by the reaction of lithium metal dendrites, soften, and flow around reacting dendrites to encapsulate reacting lithium metal dendrites to slow and/or prevent any further reaction within the cell 100. Furthermore, the particles 109 may be made of a material that does not undergo an exothermic reaction with lithium metal or other oxidizers normally present within the cell 100.

In one embodiment, the separator 107 including the particles 109 is in direct contact with the anode 111. In some embodiments, a particle layer could also be on the cathode side of the separator 107. The separator 107 may be a coating formed directly on an upper surface of the anode 111. In one embodiment, the separator 107 with particles 109 reduces the risk of a short occurring between the anode 111 and cathode 103 due to lithium metal dendrite formation, as described with respect to FIGS. 1B-1D.

FIG. 1B illustrates a lithium metal dendrite 115 formed within the cell 100. The lithium metal dendrite 115 is formed at the upper surface of the anode 111 and has penetrated both the separator 107 and the separator 105. As shown in FIG. 1B, the lithium metal dendrite 115 has also penetrated the cathode 103 thereby creating a short between the cathode 103 and the anode 111.

As a result of the short, the lithium metal dendrite 115 heats up causing a localized reaction in separator 105 and separator 107 as shown in FIG. 1C. As a result of the heating of the lithium metal dendrite 115, the portion 117 of the separator 105 surrounding the lithium metal dendrite 115 melts as shown in FIG. 1C. Similarly, the particles 119 surrounding the lithium metal dendrite 115 begin to melt as shown in FIG. 1C. As the particles 119 melt, the particles 119 encapsulate the lithium metal dendrite 115 as shown in FIG. 1D. By encapsulating the lithium metal dendrite 115, the particles 119 will control the growth of the lithium metal dendrite 115 by at least slowing and in a best case stopping the ongoing reaction of the lithium metal dendrite 115 heating and causing a short within the battery cell 100.

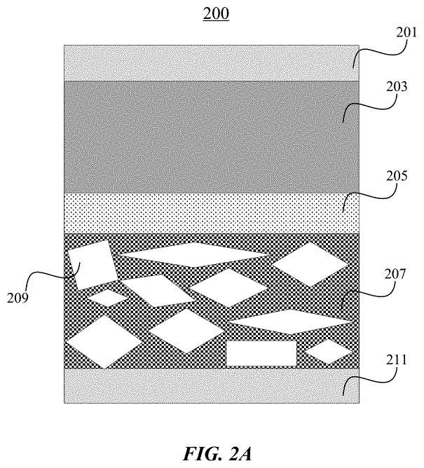

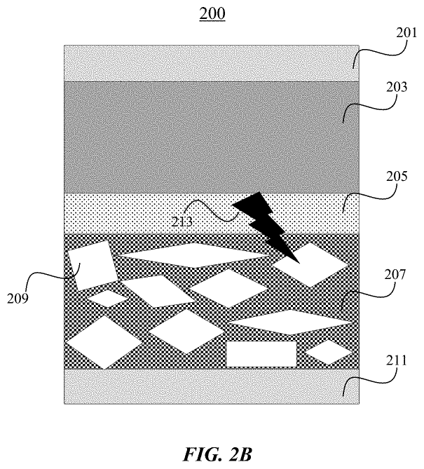

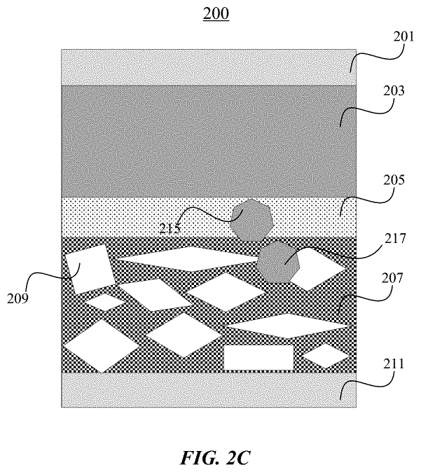

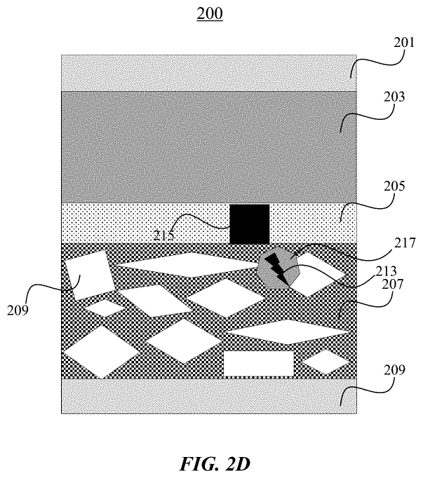

FIG. 2A illustrates a cross-section of a battery cell 200 of a lithium battery in accordance with another embodiment. The battery cell 200 includes a cathode current collector 201, a cathode 203, a separator 205, an anode 207 with particles 209, and an anode current collector 211 in one embodiment. Other embodiments may include further elements than those shown in FIG. 2A.

In one embodiment, the cathode current collector 201 is made of aluminum and the cathode 203 may be composed of a variety of lithiated mixed metal oxides such as cobalt oxide, nickel cobalt aluminate (NCA), nickel cobalt manganese oxide (NCM), or iron phosphate. The cell may include a lithium based liquid electrolyte or a lithium based solid electrolyte, as previously described above. The anode current collector 211 may be made of copper and the anode 207 may be composed of graphite, silicon oxide, carbon nano-tubes, carbon nanowires, graphene, or blends of these materials. However, unlike the embodiment of FIG. 1, the anode 207 rather than a separator includes particles 209. In one embodiment, the particles 209 may make up 50% of the volume of the anode 207. Each particle may have a diameter less than ⅓^{rd} of the thickness of the anode layer, and less than 1 um. Particles may have a broad size distribution. Placing the particles 209 within the anode 207 allows for a higher charging rate of the battery cell 200 compared to the embodiment of FIG. 1.

Like FIG. 1A, the particles 209 may be made of glass (e.g., a silicon oxide material). However, the particles 209 may be made of other materials such as copper or sand. In one embodiment, the particles 109 are beads. Generally, the particles 209 have a melting point above 150 C, a glass transition temperature below 500 C and a high enthalpy of melting such that the particles 109 can absorb heat generated by the reaction of lithium metal dendrites, soften, and flow around reacting dendrites to encapsulate reacting lithium metal dendrites to slow and/or prevent any further reaction within the cell 200. Furthermore, the particles 109 will be made of a material that does not undergo an exothermic reaction with lithium metal or other oxidizers normally present within the cell 200. As shown in FIG. 2A, the anode 207 is in direct contact with the anode current collector 211. The anode 207 with particles 209 reduces the severity of thermal runaway in the battery cell 200 due to lithium metal dendrite formation, as described with respect to FIGS. 2B-2D.

FIG. 2B illustrates a lithium metal dendrite 213 formed within the cell 200. The lithium metal dendrite 213 formed at the surface of the anode 207 and has penetrated the separator 205. As shown in FIG. 2B, the lithium metal dendrite 213 has also penetrated the cathode 203 thereby creating a short between the cathode 203 and the anode 207.

As a result of the short, the lithium metal dendrite 213 heats up causing a localized reaction in separator 205 and the anode 207 as shown in FIG. 2C. As a result of the heating of the lithium metal dendrite 213, the portion 215 of the separator 205 surrounding the lithium metal dendrite 213 melts as shown in FIG. 2C. Similarly, the particles 217 surrounding the lithium metal dendrite 213 begin to melt as shown in FIG. 2C. As the particles 217 melt, the particles 217 encapsulate the lithium metal dendrite 213 as shown in FIG. 2D. By encapsulating the lithium metal dendrite 213, the particles 217 will control the growth of the lithium metal dendrite 213 by at least slowing and in a best case stopping the ongoing reaction of the lithium metal dendrite 213 heating within the battery cell 200. Thus, the particles in anode 207 can serve as a fire block within the battery cell 200.

Reference in the specification to “one embodiment” or to “an embodiment” means that a particular feature, structure, or characteristic is included in at least one embodiment of the disclosure. The appearances of the phrase “in one embodiment” or “a preferred embodiment” in various places in the specification are not necessarily referring to the same embodiment.

While the disclosure has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

I claim:

1. A lithium battery cell comprising:
an anode;
a separator layer on the anode;
a plurality of particles, the plurality of particles configured to reduce a reaction of a lithium metal dendrite forming within the lithium battery cell; and
a cathode on the plurality of particles.

2. The lithium battery cell of claim 1, wherein the plurality of particles comprise silicon oxide.

3. The lithium battery cell of claim 1, wherein the plurality of particles comprise copper.

4. The lithium battery cell of claim 1, wherein the plurality of particles comprise sand.

5. The lithium battery cell of claim 1, further comprising:
another separator layer between the separator and the cathode;
wherein the plurality of particles are included within the separator layer that is on the anode.

6. The lithium battery cell of claim 5, wherein the plurality of particles are up to 95% of a volume of the separator layer.

7. The lithium battery cell of claim 5, wherein at least one of the plurality of particles has a diameter less than ⅓^{rd} the thickness of the separator layer and less than 1 um.

8. The lithium battery cell of claim 5, wherein the separator layer including the plurality of particles is in direct contact with a surface of the anode.

9. The lithium battery cell of claim 1, wherein the plurality of particles are included in the anode.

10. The lithium battery cell of claim 9, wherein the plurality of particles are up to 50% of a volume of the anode.

11. The lithium battery cell of claim 9, wherein at least one of the plurality of particles has a diameter less than ⅓^{rd} of a thickness of the anode, and less than 1 um.

12. The lithium battery cell of claim 9, wherein the anode comprises lithium metal that surrounds the plurality of particles.

13. The lithium battery cell of claim 1, further comprising:
a cathode current collector in contact with the cathode; and
an anode current collector in contact with the anode.

14. The lithium battery cell of claim 1, wherein the lithium battery cell is included in a rechargeable lithium-ion battery.

15. The lithium battery cell of claim 1, wherein the lithium battery cell is included in a non-rechargeable lithium battery.

16. A lithium battery cell comprising:
an anode current collector;
an anode on the anode current collector, the anode including a plurality of particles surrounded by lithium metal, wherein the plurality of particles are configured to reduce a reaction of a lithium metal dendrite forming within the lithium battery cell;
a separator on the anode;
a cathode on the separator; and
a cathode current collector on the cathode.

17. The lithium battery cell of claim 16, wherein the plurality of particles are up to 50% of a volume of the anode.

18. The lithium battery cell of claim 16, wherein at least one of the plurality of particles has a diameter less than ⅓^{rd} of a thickness of the anode, and less than 1 um.

19. A lithium battery cell comprising:
an anode current collector;
an anode on the anode current collector;
a first separator in direct contact with the anode, the separator including a plurality of particles, wherein the plurality of particles are configured to reduce a reaction of a lithium metal dendrite forming within the lithium battery cell;
a second separator on the first separator, the second separator lacking any of the plurality of particles;
a cathode on the second separator; and
a cathode current collector on the cathode.

20. The lithium battery cell of claim 16, wherein the plurality of particles are up to 95% of a volume of the separator and at least one of the plurality of particles has a diameter less than ⅓^{rd} the thickness of the separator and less than 1 um.
